(19) United States
(12) Patent Application Publication
(10) Pub. No.: US 2016/0188176 A1
(43) Pub. Date: Jun. 30, 2016

(54) Systems and Methods for Resident Space Object Visualization

(71) Applicant: Valepro, LLC, Huntsville, AL (US)

(72) Inventor: Craig Arthur Runnels, Madison, AL (US)

(21) Appl. No.: 14/984,977

(22) Filed: Dec. 30, 2015

Related U.S. Application Data
(60) Provisional application No. 62/098,545, filed on Dec. 31, 2014.

(51) Int. Cl. G06F 3/0484; G06T 11/20; H04L 29/08

(52) U.S. Cl. CPC G06F 3/04842; H04L 67/12; H04L 67/10; G06T 11/206; G06F 3/04847

(57) ABSTRACT

A system of the present disclosure has a resident space object (RSO) data server communicatively coupled to an RSO sensor system. Additionally, the system has logic that receives RSO characteristic data from the RSO sensor system and stores the RSO characteristic data in resident memory. Further, the logic receives an input from a user identifying RSO characteristic data the user desires to view, translates the RSO characteristic data into at least one geometric shape based upon the user's input, and displays the geometric shape to an output device.

### CROSS REFERENCE TO RELATED APPLICATION

This application is a continuation of and claims priority to U.S. Provisional Patent Application Ser. No. 62/098,545 entitled Systems and Methods for Space Situational Awareness Visualization and filed on Dec. 31, 2014, which is incorporated herein by reference in its entirety.

### BACKGROUND

Many resident space objects (RSOs) orbit the earth. Some RSOs include satellites and space junk, which may be natural or man-made. Monitoring RSOs is known in the art as Space Situational Awareness (SSA). There are many organizations that participate in SSA and monitor RSOs, including the Defense Advanced Research Project Agency (DARPA) using SSA systems and methods.

RSOs are monitored for many different reasons. One important reason, however, is that with intimate and precise knowledge about the RSOs, a satellite operator may be able to alter movements of an RSO and avoid impending collisions, which are often referred to as conjunctions.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram depicting a space object visualization system in accordance with an embodiment of the present disclosure.

FIG. 2 is a block diagram of an exemplary control center computing device depicted in FIG. 1.

FIG. 3 is an exemplary Unclassified Space Catalog graphical user interface (GUI) of the space object visualization system depicted in FIG. 1.

FIG. 4A is the Unclassified Space Catalog GUI of FIG. 3 showing a child window displaying resident space object (RSO) characteristic data.

FIG. 4B is the Unclassified Space Catalog GUI of FIG. 3 showing a zoom selection window.

FIG. 4C is a GUI showing geometric shapes resulting from a zoom of the data shown in FIG. 4B.

FIG. 4D is a GUI showing geometric shapes resulting from a zoom of the data shown in FIG. 4C.

FIG. 5 is an exemplary Collision Avoidance GUI of the space object visualization system depicted in FIG. 1.

FIG. 6 is an exemplary Conjunction Detail GUI of the Collision Avoidance GUI of FIG. 5.

FIG. 7 is the Conjunction Detail GUI of FIG. 5 showing child window displaying RSO characteristic data.

FIG. 8 is an exemplary Delta Velocity Required GUI of the space object visualization system depicted in FIG. 1.

FIG. 9 is the Delta Velocity Required GUI of FIG. 8 showing a child window displaying RSO characteristic data.

FIG. 10 is a flowchart of exemplary architecture and functionality of the control logic depicted in FIG. 2.

### DETAILED DESCRIPTION

Embodiments of the present disclosure generally pertain to systems and methods for space situational awareness (SSA) visualization. A system in accordance with one exemplary embodiment of the present disclosure automates visualization of characteristics of resident space objects (RSOs), and the automated visualization conveys to a user various characteristics related to a plurality of RSOs that are monitored by the system. In particular, the exemplary system for SSA visualization receives RSO characteristic data indicative of characteristics of RSOs from an RSO data server and translates the received RSO characteristic data into graphical representations of the RSO characteristics, which are displayed to a graphical user interface.

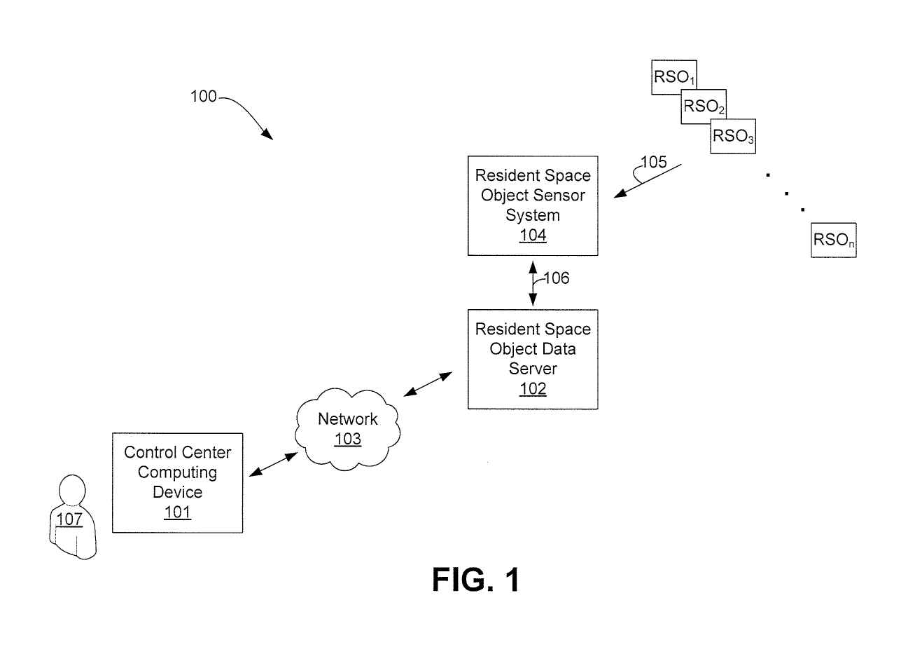

FIG. 1 is a block diagram of a resident space object (RSO) visualization system 100 in accordance with an embodiment of the present disclosure. The RSO visualization system 100 comprises a resident space object sensor system 104 that detects characteristics related to a plurality of resident space objects RSO₁-RSOₙ. The RSOs may include satellites, debris, or any other type of object that is orbiting the earth.

While a single RSO sensor system 104 is shown in FIG. 1, this is merely for exemplary purposes only. There are numerous systems employed throughout the world that track, monitor, and collect RSO characteristic data. Thus, for purposes of the present disclosure, the RSO sensor system 104 is any type of system known in the art or future-developed that tracks, monitors, and collects RSO characteristic data.

The RSO sensor system 104 may employ a number of technologies to track, monitor, and collect RSO characteristic data. In this regard, the RSO sensor system 104 is communicatively coupled via a communication link 105 to the RSOs RSO1-RSOn. The type of communication link 105 is dependent upon the type of sensing technology used by the RSO sensor system 104. For example, the RSO sensor system 104 may comprise monitoring telemetry subsystems, radar, astronomical radio telescopes equipped with radar, infrared detectors, optical sensor, or specialized cameras. Notably, for purposes of the present disclosure, the RSO sensor system 104 represents any type of system(s) that tracks, monitors, and collects data indicative of characteristics relating to a plurality of RSOs.

The system 100 further comprises a resident space object data server 102. The RSO data server 102 is any type of computing device that receives and stores data obtained or measured by the RSO sensing system 104 via the communication link 106. The communication link 106 may be effectuated by via a network or a direct connection. There are a variety of examples of RSO data servers. For example, the Joint Space Operations Center Mission System (JMS) retrieves, stores, and provides data indicative of characteristics related to RSOs. Other examples include spacetrack.org and Orbit Outlook Data Archive. Notably, each of these exemplary systems receives, stores, and serves RSO characteristic data upon request or otherwise to remote systems for a variety of purposes. For example, the characteristic data may be used to track RSOs, determining imminent conjunctions, and formulating collision avoidance processes. Note that in the satellite technology arena, a conjunction refers to an incident wherein one RSO collides or interferes with another RSO while the RSOs are in orbit.

The system 100 further comprises a control center computing device 101 that is communicatively coupled to the resident space object data server 102. Note that in the exemplary system 100 shown in FIG. 1, the control center computing device 101 is communicatively coupled to the resident space object data server 102 via a network 103. However, the control center computing device 101 may also be communicatively coupled to the resident space object data server 120 via a direct communication link.

In operation, the resident space object sensor system 104 tracks, monitors, and collects RSO characteristic data related to a plurality of RSOs RSO₁-RSOₙ. As described hereinabove, many different types of technologies may be used to collect the RSO characteristic data. Thus, the present disclosure encompasses any type of known or future-developed system and/or device that tracks, monitors, and/or collects the RSO characteristic data.

The RSO data server 102 receives the RSO characteristic data collected, and stores the data resident on the RSO data server 102. In one embodiment, the RSO data server 102 may request RSO characteristic data from the RSO sensing system 104. In another embodiment, the RSO sensing system 104 may periodically download the RSO characteristic data to the RSO data server 102. Whether requested or periodically downloaded, the RSO characteristic data is provided to the RSO data server 102 via the communication link 106.

In one embodiment, the control center computing device 101 specifically requests RSO characteristic data from the RSO data server 102. In another embodiment, the RSO data server 102 periodically downloads RSO characteristic data to the control center computing device 101. In either embodiment, upon receipt the control center computing device 101 stores the received RSO characteristic data resident on the control center computing device 101.

A user 107 may then navigate the RSO characteristic data via a graphical user interface (GUI) on the control center computing device 101. In this regard, the control center computing device 101 controls visualization of the RSO characteristic data by receiving RSO characteristic data selection input from the user, translating the RSO characteristic data into a plurality of graphical elements, and displaying the graphical elements in the GUI for visual perception by a user of the control center computing device 101. This process is described further herein.

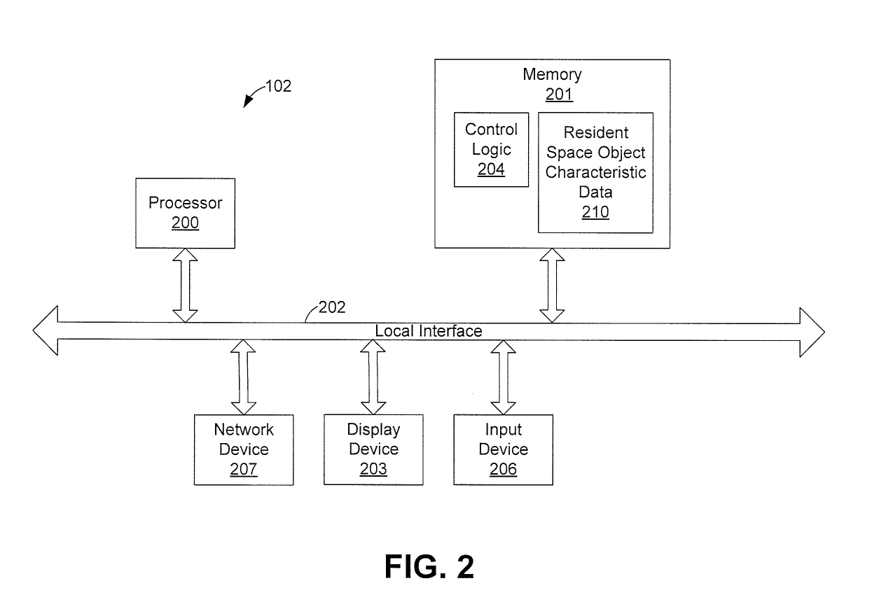

FIG. 2 depicts an exemplary embodiment of the control center computing device 101 of FIG. 1. The device 101 comprises at least one conventional processing element 200, such as a central processing unit (CPU) or digital signal processor (DSP), which communicates to and drives the other elements within the device 101 via a local interface 202. Furthermore, a display device 203, such as, for example, a screen, can be used to visually display RSO characteristic data 210 to the user 107 (FIG. 1). Additionally, an input device 206, such as a keypad or keyboard, can be used by the user 107 to input data into the device 101. Also, a microphone 48 can be used to input acoustic sound, such as speech, into the device 35, and a speaker 50 can be used to output acoustic sound from the device 35. In addition, the device 35 has a network device 207 for receiving RSO characteristic data from the RSO data server 102 (FIG. 1).

The control center computing device 101 further comprises control logic 204 stored in memory 201 of the device 101. The control logic 204 is configured to establish a data connection with the RSO data server 102 (FIG. 1) through the network 103 in order to request or periodically receive RSO characteristic data from the RSO data server 102. Upon receipt, the control logic 204 stores the received RSO characteristic data 210 in memory 201. Note that the control logic 204 may be software, hardware, or any combination thereof. When implemented in software, the control logic 204 can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The RSO characteristic data 210 comprises any data indicative of parameters associated with the RSOs RSO₁-RSOₙ. In this regard, the RSO characteristic data 210 may comprise any data indicative of parameters associated with the RSOs RSO1-RSOn that are detected by the RSO sensor system 104. Additionally, the RSO characteristic data 210 may comprise any data that is associated with the RSOs RSO1-RSOn that is provided by the RSO data server 102.

As mere examples, the RSO sensor system 104 (FIG. 1) may detect parameters associated with RSO motion, including velocity, acceleration, or the like. Other data from the RSO sensor system 104 may include data indicative of the mean motion of the RSO with respect to time. Other types of data that may be obtained by the sensor system 104 includes orbit inclination (in degrees), right ascension of ascending node (in degrees), eccentricity, argument of perigee (in degrees), mean anomaly (in degrees), mean motion (revolutions per day), revolution number at its epoch. Other types of RSO characteristic data 210 may comprise observation data, measurement data, and observation grade data. In this regard, observation data is any data indicative of how well an RSO is performing or has performed. The measurement data includes any type of data than can be inferred from the observation data. The RSO characteristic data 210 may further comprise a grade of the observation.

This information may be provided to the RSO data server 102 in real time, and passed on to the central computing device 101 upon request. Additionally, the RSO characteristic data 210 may comprise data indicative of common name of the RSO based upon the Satellite Catalog and a NORAD Catalog number (NORAD refers to North American Aerospace Defense). Further, the RSO characteristic data 210 may comprise an element set (elset) classification, which provides the type of equation for use of the location of a satellite at a fixed point in time, or epoch. Other data may include data indicative of a period, an apogee, a perigee, and a semi-major axis of the RSO. These are mere examples, and fewer, more, or different RSO characteristics may be provided by the RSO data server 102 in other embodiments.

In one embodiment, the system 100 (FIG. 1) uses space-track.org to obtain its RSO characteristic data 210. In one embodiment, space-track.org employs an application program interface (API) that allows users to retrieve data from its database (not shown). In such an embodiment, the API may allow the user 107 to submit a uniform resource locator (URL) with configurable parameters to access RSO characteristic data. In one embodiment, the API employs two-line element (TLE) data sets, that comprise some or most of the data described hereinabove. Thus, a user can query particular classes of the RSO characteristic data on the RSO data server 102. For example, a query identifying class tle (two-line element) may return historical records of the RSOs. A query identifying class tle_latest may return the most recent tles added to the RSO data server database. These are merely exemplary queries, and other queries are possible in other embodiments.

In operation, the control logic 204 translates the RSO characteristic data 210 into graphical objects for ease of visualization by the user 107. In this regard, the control logic 204 translates the RSO characteristic data 210 into geometric shapes that are grouped, colored, and scaled to denote the RSO characteristic data 210.

As an example, the user 107 may desire to view information that conveys groups of RSOs by particular country-of-origin. In such a scenario, the user 107 selects a country view of the RSO characteristic data 210 via the input device 206, and in response, the control logic 204 translates the RSO characteristic data 210 corresponding to each country into graphical elements and displays the graphical elements to the display device 203. In such a scenario, the control logic 204 queries the database for RSO characteristic data 210 based upon the country of origin, and translates the RSO characteristic data returned on the country query of the RSO characteristic data 210 into graphical elements that convey each country and the RSOs associated with each country.

In one embodiment, the control logic 204 translates the RSO characteristic data 210 that identifies RSO apogees into a graphical element that is sized based upon the RSO characteristic data indicative of the apogees. For example, the larger the apogee relative to other apogees the larger the graphical element.

In one embodiment, the control logic 204 further calculates the parameters associated with a conjunction (i.e., a collision) between two RSOs. For example, the control logic 204 may calculate if/when an RSO will experience a conjunction with another RSO, estimates the time of the conjunction, and determines the closeness and change in velocity of the RSOs involved in the potential conjunction. Note that different methods may be employed to calculate the conjunction parameters. In one embodiment, the control logic 204 may compare RSO characteristic data associated with one RSO to every other RSO characteristic data of every other RSO in the RSO characteristic data 210. In such a comparison, the control logic 204 defines a 3-day window of interest, and propagates to the start time of the 3-day period. The control logic 204 then begins conjunction calculation by propagating the first RSO and the next RSO identified in the RSO characteristic data 210 to determine if the two RSOs are within a threshold distance, e.g., five kilometers, of each other. The control logic 204 performs the same calculations for each RSO within the RSO characteristic data 210. When through the calculated propagation, the control logic 204 determines that two RSOs are within the threshold distance, the control logic 204 translates the possible collision detected into a graphical element, and displays the graphical element to the display device 203, based upon a user query of possible conjunctions.

In one embodiment, the RSO data server 102 is updated in real time. Additionally, the central computing device 101 requests periodic updates, e.g., every five minutes, of the RSO characteristic data 210. Thus, the central computing device 101 is capable of displaying to the user 107 in near real time update RSO characteristic data 210.

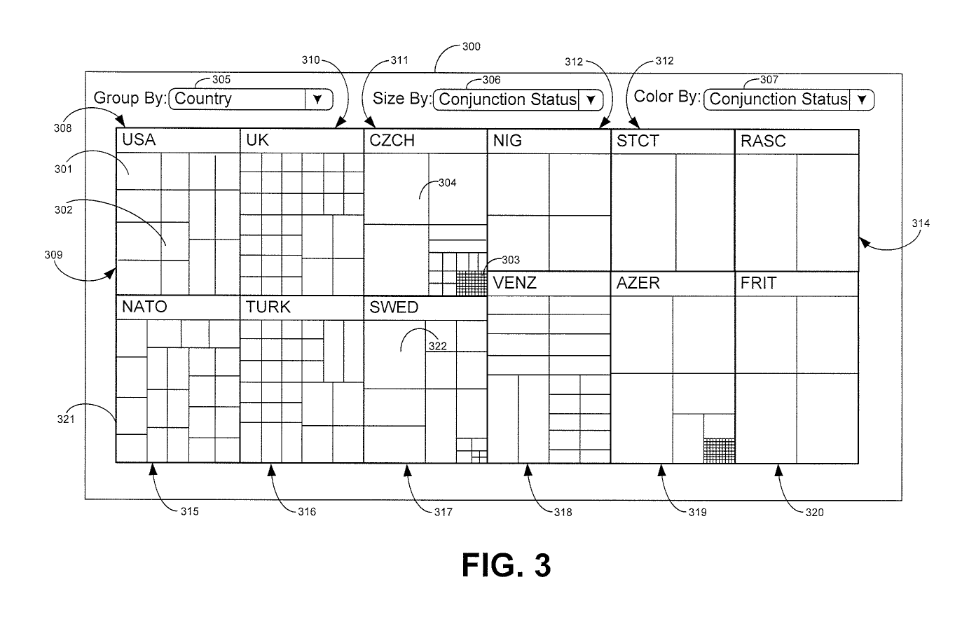

FIG. 3 depicts an exemplary graphical user interface (GUI) 300 in accordance with an embodiment of the present disclosure. In one embodiment, the control logic 204 (FIG. 2) comprises a Home GUI (not shown) that displays a number of view selections from which the user 107 (FIG. 1) may select to determine how the control logic 204 translates and displays the RSO characteristic data 210 (FIG. 2). As mere examples, the Home GUI may comprise view selections comprising of Unclassified Space Catalog, Collision Avoidance, Overflight, Two-Line Element, Delta Velocity Required, Anomalous Maneuver, Orbit Outlook, JMS TLE View, and Allied User View.

The exemplary GUI 300 comprises a “Group by” pulldown menu 305, a “Size By” pulldown menu 306, and a “Color By” pulldown menu 307. In addition, the GUI 300 comprises an RSO characteristic data pane 308 in which the control logic 204 displays graphical elements translated from the RSO characteristic data 210. Which RSO characteristic data 210 that the control logic 204 translates and displays into particular graphical elements in the pane 308 depends upon the user's view selection from the Home GUI.

In the embodiment depicted, the control logic 204 translates the RSO characteristic data 210 into quadrilaterals; however, the control logic 204 may translate the RSO characteristic data 210 into other shapes in other embodiments.

The “Group By” pulldown menu 305 may comprise a number of selection options. In one embodiment, when the user 107 selects the “Group By” pulldown menu 305, the control logic 204 provides optional selections, including selections for “Country,” “Constellation Name,” “Object Type,” and “STATUS.” Note that these optional selections are not limiting. Further note that in one embodiment, the available optional selections may be configured by the user 107. In this regard, any RSO characteristic data 210 may be used as an optional selection in the “Group By” pulldown menu as configured by the user 107. Depending upon the selection from the user 107, the control logic 204 translates the RSO characteristic data 210 dependent upon the selection and displays geometric shapes grouped by the selection made by the user 107.

In response to selection of “Country” from the pulldown menu 305, the control logic 204 translates the RSO characteristic data 210 into graphical elements grouped by the country of origin. In response to selection of “Constellation Name” from the pulldown menu 305, the control logic 204 translates the RSO characteristic data 210 into graphical elements grouped by the constellation name. Note that a constellation of RSOs is a group of satellites that work in concert to perform a particular function, e.g., under shared control or overlap in ground coverage. In response to selection of “Object Type” from the pulldown menu 305, the control logic 204 translates the RSO characteristic data 210 into graphical elements grouped by RSO object type, e.g., payload, rocket body, and/or debris. In response to selection of “STATUS” from the pulldown menu 305, the control logic 204 translates the RSO characteristic data 210 into graphical elements grouped by the most recent status of the satellite, e.g., whether the satellite is in telemetry only or whether the satellite responds upon a ping.

The “Size By” pulldown menu 306 may also comprise a number of selection options. In one embodiment, when the user 107 selects the “Size By” pulldown menu 306, the control logic 204 provides optional selections, including selections for “Apogee (Orbit),” “RCS (Orbit),” and “Conjunction Status.” Note that “RCS” refers to the radar cross section of the orbit of an RSO. Note that these optional selections are not limiting. Further note that in one embodiment, the available optional selections may be configured by the user 107. In this regard, any RSO characteristic data 210 may be used as an optional selection in the “Size By” pulldown menu as configured by the user 107.

In response to selection of “Apogee” from the pulldown menu 306, the control logic 204 translates the RSO characteristic data 210 into graphical elements the dimensions of which are determined based upon the apogee of each of the RSOs related to the RSO characteristic data. In this regard, the larger the apogee of the particular RSO, the larger the graphical element

In response to selection of “RCS (orbit)” from the pulldown menu 306, the control logic 204 translates the RSO characteristic data 210 into graphical elements the dimensions of which are determined by the control logic 204 based upon the size of the RCS orbit. In this regard, the larger the RCS orbit of an RSO, the larger the graphical element. In response to selection of “Conjunction Status” from the pulldown menu 306, the control logic 204 translates the RSO characteristic data 210 into graphical elements the dimensions of which are determined by the conjunction status of the RSOs, which is calculated by the control logic 204 as described hereinabove.

The “Color By” pulldown menu 307 may also comprise a number of selection options. In this regard, the user 107 may select a particular parameter for which he/she desires to exhibit identifying colors for conveying particular RSO characteristic data 210. In one embodiment, when the user 107 selects the “Color By” pulldown menu 307, the control logic 204 provides optional selections, including selections for “Country,” “Launch Date,” “RCS (orbit),” “Conjunction Status,” “Observation Epoch,” and “Object Type.” Note that these optional selections are not limiting. Further note that in one embodiment, the available optional selections may be configured by the user 107. In this regard, any RSO characteristic data 210 may be used as an optional selection in the “Color By” pulldown menu as configured by the user 107.

In response to selection of “Country” from the pulldown menu 307, the control logic 204 translates the RSO characteristic data 210 corresponding to the country of origin into graphical elements wherein each country exhibits a different color. This allows easier discernment of the RSOs associated with each country. In response to selection of “Launch Date” from the pulldown menu 307, the control logic 204 translates the RSO characteristic data 210 corresponding to the launch dates of the plurality of RSOs into graphical elements wherein RSOs having similar launch dates exhibit similar colors. In response to selection of “RCS (orbit)” from the pulldown menu 307, the control logic 204 translates the RSO characteristic data 210 corresponding to the country of origin into graphical elements wherein each graphical element having similar RCS orbits are colored similarly. In response to selection of “Conjunction Status” from the pulldown menu 307, the control logic 204 translates the RSO characteristic data 210 corresponding to the conjunction status wherein each similar conjunction statuses exhibit similar colors. In response to selection of “Observation Epoch” from the pulldown menu 307, the control logic 204 translates the RSO characteristic data 210 corresponding to the observation epochs into graphical elements wherein similar observation epochs are colored similarly. In response to selection of “Object Type” from the pulldown menu 307, the control logic 204 translates the RSO characteristic data 210 corresponding to the object type into graphical elements wherein similar object types exhibit similar colors, e.g., blue means debris, pink means payload, and grey means rocket body.

As noted hereinabove, the user 107 may select a particular view from the Home GUI (not shown). In one embodiment, the user 107 may select the following views: Unclassified Space Catalog, Collision Avoidance, Overflight, Two-Line Element, Delta Velocity Required, Anomalous Maneuver, Orbit Outlook, JMS TLE View, and Allied User View, as also enumerated hereinabove. Each particular view conveys different instantiations of the RCS characteristic data 210.

When the user 107 selects Unclassified Space Catalog from the Home GUI, the control logic 204 translates the RSO characteristic data 210 related to unclassified RSOs into graphical elements and displays the graphical elements to the user 107 via the display device 203 (FIG. 2). In regards to the Unclassified Space Catalog view, the control logic 204 translates the RSO characteristic data 210 into a plurality of geometric shapes, e.g., quadrilaterals, whose size and color convey information about the unclassified RSOs. Note that other shapes may be possible in other embodiments.

In the Unclassified Space Catalog view, the GUI 300 comprises the window pane 308 that displays the translated RSO characteristic data 210. The control logic 204 translates RSO characteristic data 210 related to each country, and displays the geometric shapes corresponding to each of the RSOs grouped by country of origin. The graphical element pane 308 comprises a plurality of blocks 309-320, wherein each block 309-320 corresponds to a particular country. Within each block 309-320 is one or more of sub-blocks 301-304. Note that every sub-block is not identified with a reference numeral for ease of description and explanation; however, the control logic 204 translates the RSO characteristic data 210 into geometric shapes, wherein at least a portion of RSO identified in the RSO characteristic data 210 is represented.

In the example provided, the block 309 comprises geometric shapes that convey RSOs related to the United States of America (USA), i.e., the country of origin. Within the block 309 is a plurality of sub-blocks 301 and 302 (note that only two of the plurality are referenced for ease of description). In translation of the RSO characteristic data 210, the control logic 204 determines a particular size of the RSO, and displays geometric shapes that are sized according to a selection by the user 107. As an example, if the user 107 elects to have the size of the geometric shapes be representative of the size of the RSO, the control logic 204 translates the RSO characteristic data 210 corresponding to the RSO's size into geometric shapes that reflect the RSO's size. In the example provided, block 301 is a particular size, and block 302 is a larger size. Thus, the control logic 204 determines from the RSO characteristic data 210 that the RSO 302 is bigger than RSO 301 and translates representative geometric shapes that convey this size difference, i.e., the sub-block 301 is smaller than the sub-block 302.

As another example, the block 311 comprises geometric shapes that convey information related to RSOs originating with the Czech Republic, i.e., the country of origin. Within the block 311 is a plurality of sub-blocks 303 and 304 (note that only two of the plurality are referenced for ease of description). In translation of the RSO characteristic data 210, the control logic 204 determines sizes of the RSOs, and displays geometric shapes representative of the relative sizes of the RSOs. In this regard, block 304 is a particular size, and block 303 is much smaller in size. Thus, the control logic 204 determines from the RSO characteristic data 210 that the RSO 304 is bigger than RSO 303 and translates the RSO characteristic data 210 into representative geometric shapes that convey this size different, i.e., the sub-block 303 is much smaller than the sub-block 304.

Not only does the control logic 204 translate the RSO characteristic data into geometric shapes contained within the blocks 309-320 that exhibit relative sizes, the control logic 204 also translates the RSO characteristic data 210 into geometric shapes between the blocks 309-320 that exhibit relative sizes. In this regard, RSOs originating with Sweden are represented by block 317. The block 317 comprises a sub-block 322 indicative of an RSO whose country of origin is Sweden. In this particular example, the control logic 204 determines that the RSOs corresponding to sub-blocks 301-304 are smaller than the RSO corresponding to sub-block 322. Thus, the control logic 204 translates the RSO characteristic data 210 into geometric shapes whose sizes are representative of the relative size of the RSOs between the country blocks 309-320. Notably, the RSO represented by the sub-block 322 is larger than the RSOs represented by the sub-blocks 301-304; therefore, the sub-block 322 is larger than the sub-blocks 301-304.

Note that the control logic 204 translates a first parameter of the RSO characteristic data 210 into blocks, as described. As an example, each block may represent a country or a constellation, which is the first parameter of RSO characteristic data. Further, for each block the control logic 204 translates a second parameter of the RSO characteristic data 210 into sub-blocks, wherein data indicative of each generated sub-block is associated with the first parameter. For example, each sub-block may represent a single RSO. Where the first parameter represents a country and the second parameter represents an RSO, the country may be the origin of a plurality of RSOs. Therefore, the control logic 204 would display a block having a plurality of sub-blocks.

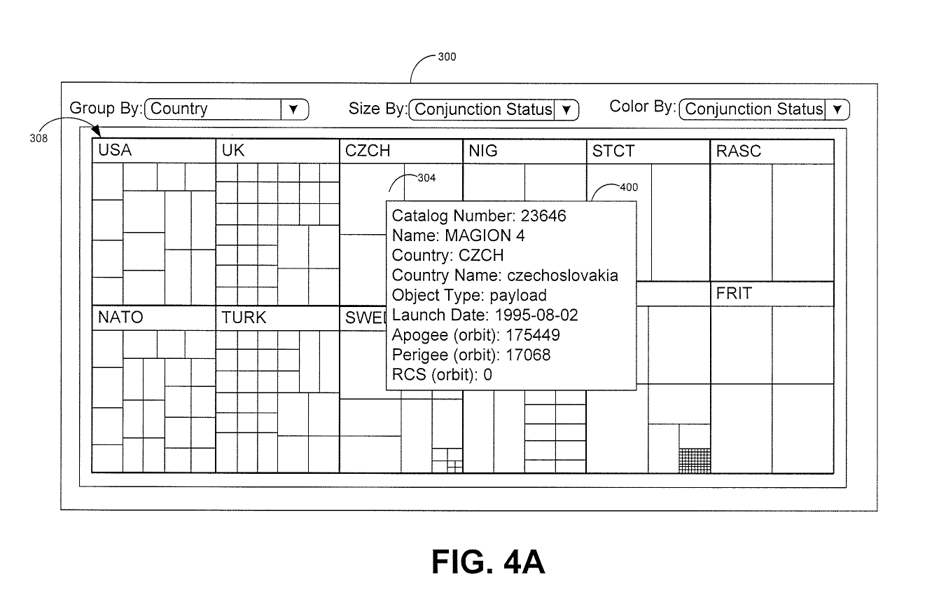

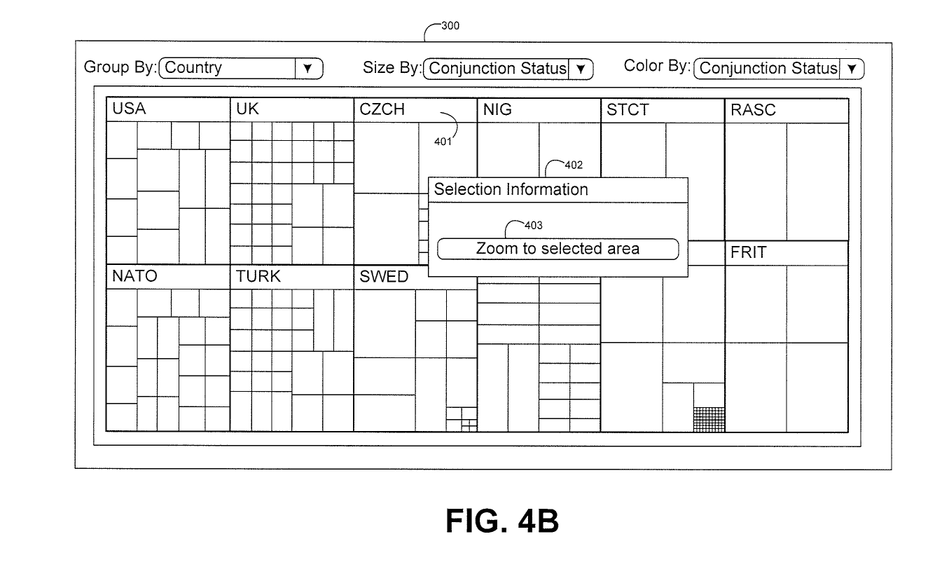

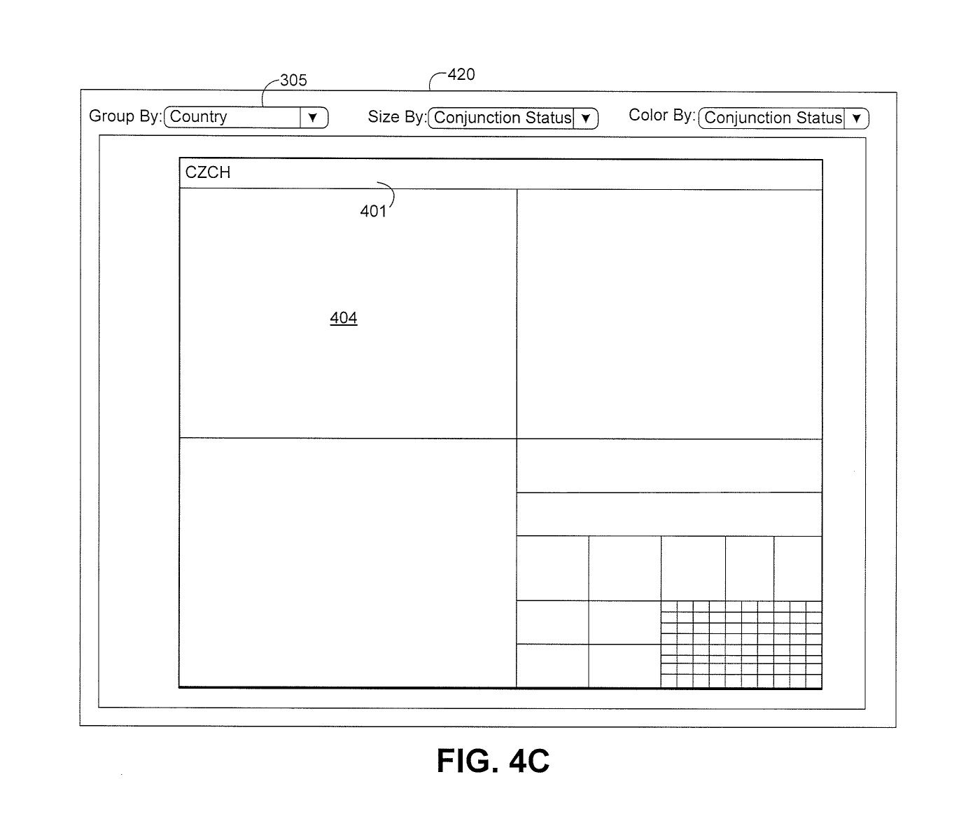

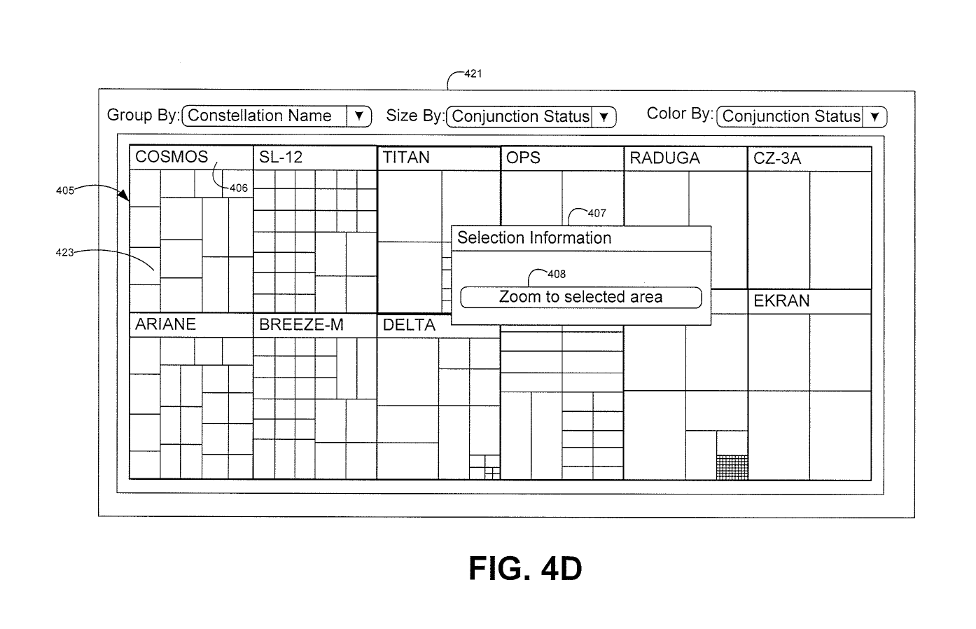

Further note that in one embodiment, each sub-block 301-304 represents a single RSO. In such an embodiment, a user 107 may desire to view details about the particular RSO corresponding to one of the sub-blocks 301-304. If the user 107 so desires, the user 107 may click a single sub-block, and the control logic 204 displays a child window that describes the RSO to which the sub-block relates. FIG. 4A depicts an exemplary scenario for displaying such information to the user 107. In the example of FIG. 4A, the user 107 clicks on the sub-block 304. In response to the user input, the control logic 204 displays a child window 400 that contains, for example, data indicative of the RSO's catalog number, name, country, object type, launch date, apogee (orbit), perigee (orbit), and radar cross section (RCS) (orbit). Note that the data listed in the child window 400 may contain other types of RSO characteristic data 210 in other embodiments, and the above-referenced data is not limiting. In one embodiment, the RSO characteristic data 210 that is displayed in the child window 400 is configurable by the user 107, and may include any user-selections of the RSO characteristic data 210.

When in the Unclassified Space Catalog view as depicted in FIG. 3, the user 107 may select to view the RSO characteristic data 210 in different ways. As an example, the user 107 may select “Country” from the “Group By” pulldown menus 305, which displays the GUI 300 depicted in FIG. 3. In response, the control logic 204 translates the RSO characteristic data 210 into blocks and sub-blocks demarcated by particular countries.

In another embodiment, as described hereinabove, the user 107 may select to view the translated RSO characteristic data 210 based upon “Constellation Name,” “Object Type,” or “Status” from the “Group By” pulldown 305. In such an embodiment, the control logic 204 translates the RSO characteristic data 210 into blocks 309-320 such that each block 309-320 either represents a Constellation Name, e.g., COSMOS, BREEZE-M, and TITAN, Object Type, e.g., payload, rocket body, or debris, or Status, e.g., 0 or 9, wherein the numerals represent predefined statuses of the RSOs.

Additionally, the user 107 may select to have the geometric shapes sized by “Apogee,” “RCS (orbit),” or “Conjunction Status.” As an example, in FIG. 3, the geometric shapes, i.e., sub-blocks 301-304 are sized based upon the size of the apogee of the particular RSO to which the sub-block corresponds. In the example of FIG. 3, the apogee of sub-block 301 is greater than the apogee of sub-block 302; therefore the size of sub-block 301 corresponds to a larger apogee than sub-block 302. Additionally, sub-block 304 represents an RSO having an apogee that is greater than the RSO represented by sub-block 303. Note that the sizes of the sub-blocks 301-304 are relative to the sizes of the apogees of the RSOs.

Similarly, the control logic 204 may also size the sub-blocks, based upon user selection, relative to the RSO's RCS (orbit) and/or Conjunction status. In the example of the RCS (orbit), an RSO having a larger RCS (orbit) would be represented by a geometric shape that is larger than an RSO having a smaller RCS (orbit). In the example of conjunction status, as described hereinabove, the control logic 204 calculates a RSOs conjunction status. Further, the control logic 204 translates the conjunction status of each RSO into a geometric shape that is sized relative to the RSO's conjunction status. In this regard, the more likely the RSO may be involved in a conjunction, the larger the sub-block 301-304, and the less likely the RSO may be involved in a conjunction, the smaller the sub-block 301-304.

Additionally, the control logic 204 may color the geometric shape a particular color based upon the selection made by the user in the “Color By” pulldown 307. For example, if the user 107 selects the “Color By” “Launch Date,” the control logic 204 may apply a gradation of color, e.g., differing shades of blue, that convey the launch dates of the RSOs represented by the geometric shapes. In such a scenario, the control logic 204 translates the RSO characteristic data 210 into geometric shapes colored based upon selection made by the user 107. In this regard, the user may elect to color the sub-blocks 301-304 based upon country, radar cross section (RCS) (orbit), conjunction status, observation epoch, or object type.

When the user 107 selects Allied User View, the control logic 204 translates the RSO characteristic data 210 into geometric shapes based upon allied satellite organizations. In such an example, via the pulldown menus 305-307, the user 107 may configure the how the translated RSO characteristic data 210 may be displayed. Similar to the Unclassified Space Catalog, the user may select to have the control logic 204 to translate the RSO characteristic data 210 and display geometric shapes grouped in blocks based upon country of origin, constellation name, object type, or status. Further, the user may select to have the control logic 204 translate the RSO characteristic data 210 and display geometric shapes that are sized based upon RCS (orbit), conjunction status, or apogee (orbit). Also, the user 107 may select to have the control logic 204 translate the RSO characteristic data 210 and display geometric shapes that are colored based upon country, launch date, RCS (orbit), conjunction status, observation epoch, or object type. This is similar to the translation of the RSO characteristic data 210 that occurs with reference to the Unclassified Space Catalog view described hereinabove.

When the user 107 selects Collision Avoidance from the Home GUI, the control logic 204 translates calculations related to conjunction, which are described hereinabove, into geometric shapes. Similar to the Unclassified Space Catalog view, the user 107 may select parameters from pulldown menus 305-307 that determine how the control logic 204 translates the RSO characteristic data 210 and displays geometric shapes representative of the translated RSO characteristic data 210 to the display device 203 (FIG. 2). In this regard, the translated RSO characteristic data 210 may be displayed grouped by country, constellation name, object type, and status, it may be displayed sized by apogee, RCS, conjunction status, or object type, or it may be displayed colored by country, launch date, RCS, conjunction status, observation epoch, or object type.

FIG. 4B depicts another exemplary function of the GUI 300 in accordance with an embodiment of the present disclosure. As noted hereinabove, the pane 308 comprises a plurality of blocks 309-320 (FIG. 3), which are also depicted without reference numerals in FIG. 4B for simplicity. Further note that each of the blocks 309-320 (FIG. 3) comprise a plurality of sub-blocks 301-304 (FIG. 3), and in the embodiment depicted, each sub-block 301-304 represents RSOs associated with a particular country. For example, the sub-blocks in the “USA” block each represent an RSO associated with the United States of America.

In the embodiment depicted in FIG. 4B, each country block comprises a heading bar 401. Note that only one heading bar 401, the heading bar for Czechoslovakia, is numbered; however, each block associate with each of the different countries comprises a heading bar.

When a user 107 (FIG. 1) selects or otherwise clicks on the heading bar 401, the control logic 204 (FIG. 2) displays a child window 402. The child window 402 comprises a selectable “Zoom to selected area” button 403. As shown in FIG. 4C, when the user 107 selects or otherwise clicks on the button 403, the control logic 204 displays a GUI 420. In this regard, the control logic 204 translates the RSO characteristic data 210 related to the country identified by the selected heading bar 401 into a visible subset of geometric shapes, i.e., sub-blocks 404, that are larger than the sub-blocks depicted in FIG. 4B. In the example provided, the control logic 204 zooms in on the geometric shapes corresponding to each of the RSOs that are associated with Czechoslovakia.

Note that the user 107 may desire to further view a subset of the visible subset of RSOs associated with Czechoslovakia. In this regard, the user 107 may elect to view a portion of the visible subset corresponding to the RSOs' constellation names. To effectuate this, the user 107 may select “Constellation Name” from the “Group By” pulldown menu 305. In response, the control logic 204 filters the visible subset of FIG. 4C by constellation names and displays the GUI 421 depicted in FIG. 4D.

The GUI 421 comprises a plurality blocks 405 wherein each block 405 comprises a plurality of sub-blocks 423 representative of the RSOs associated with the identified constellation name. As an example, block 405 represents the constellation “COSMOS,” and each sub-block 423 represents an RSO associated with the constellation.

The user 107 may further view a subset of the constellation name visible subset. In this regard, the user 1076 may select or otherwise click on the heading bar 406. In response, the control logic 204 displays the child window 407. To further zoom in on the RSO characteristic data related to the constellation “COSMOS,” the user 107 selects a “Zoom to selected area” pushbutton 408. In response to the selection, the control logic 204 translates the RSO characteristic data 210 associated with the constellation into geometric shapes, e.g., sub-blocks, wherein each sub-block is larger than the sub-blocks of FIG. 4D. Note that this process of user selection, filtering, translation, and display can continue until only a single RSO is represented.

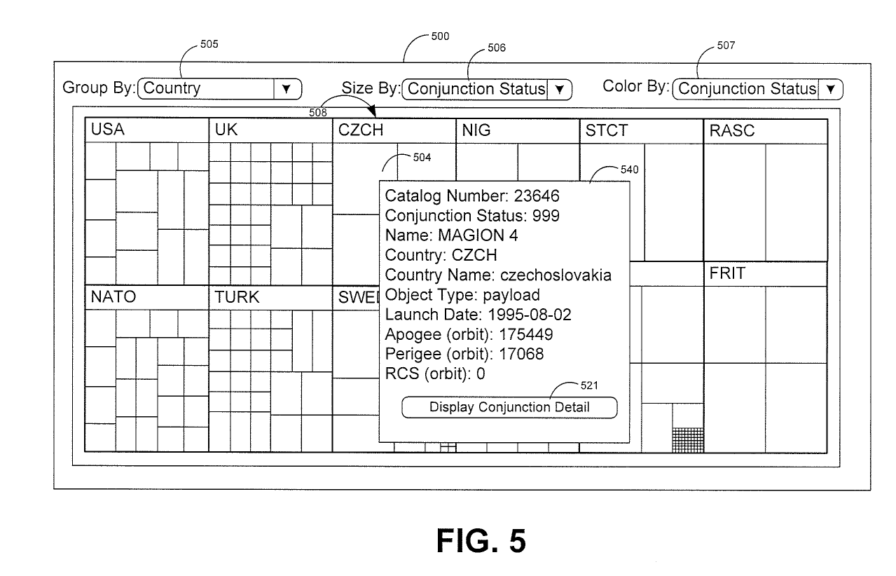

An exemplary Collision Avoidance view GUI 500 is shown in FIG. 5. The control logic 204 displays the translated data in the form of geometric shapes that convey potential conjunctions that may occur over a pre-determined period of time, e.g., twenty-four hours. In one embodiment, the two or more geometric shapes corresponding to the potential conjunction calculated may exhibit a prominent and easily recognizable color, e.g., red.

In the Collision Avoidance View, the RSO characteristic data 210 is translated such that each sub-block 501-504 represents an RSO. The translated RSO characteristic data is displayed grouped by country in pulldown menu 505, sized by apogee in pulldown menu 506, and colored by conjunction status in pulldown menu 507. In this regard, the colors of the sub-blocks 501-504 indicate the conjunction status. As an example, if the RSO represented by the sub-block is on course to collide with another RSO then the block is red. If the RSO represented by the sub-block 501-504 is not in jeopardy of a collision then the sub-block is colored green.

As an example, assume that sub-block 504 is red. If a user 107 clicks on the sub-block 504, the control logic 204 displays the calculated RSO characteristic data 210 corresponding to conjunction of the RSO associated with the sub-block 504 in a child window 540. The information displayed may be the catalog number, conjunction status, e.g., 999 if the RSO is in jeopardy of collision, name, country, country name, object type, launch date, apogee (orbit), perigee (orbit), and RCS (orbit). Note that the data listed in the child window 540 may contain other types of RSO characteristic data 210 in other embodiments, and the above-referenced data is not limiting. In one embodiment, the RSO characteristic data 210 that is displayed in the child window 540 is configurable by the user 107, and may include user-selections of any of the RSO characteristic data 210.

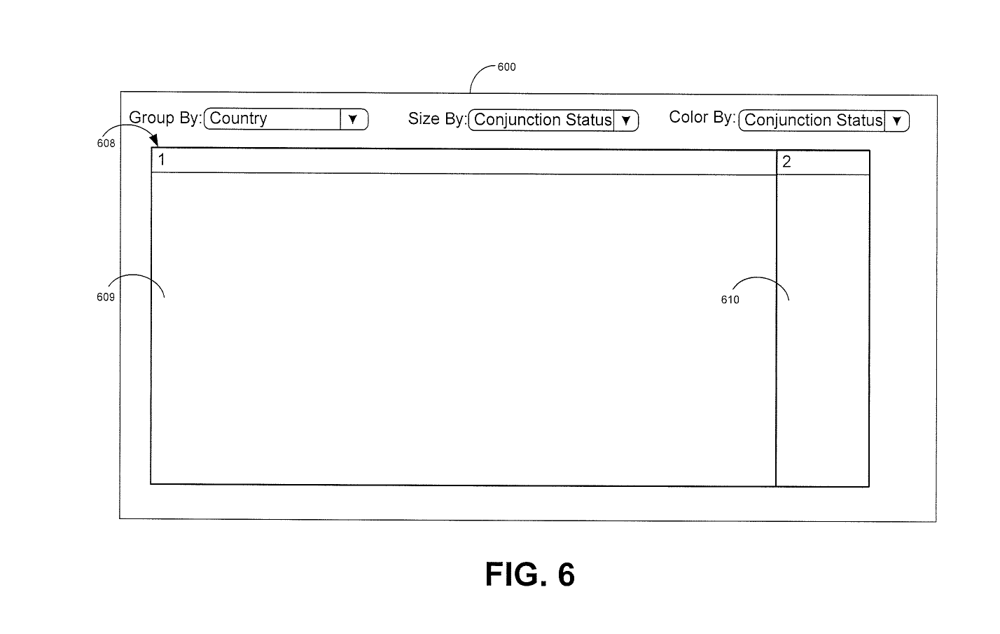

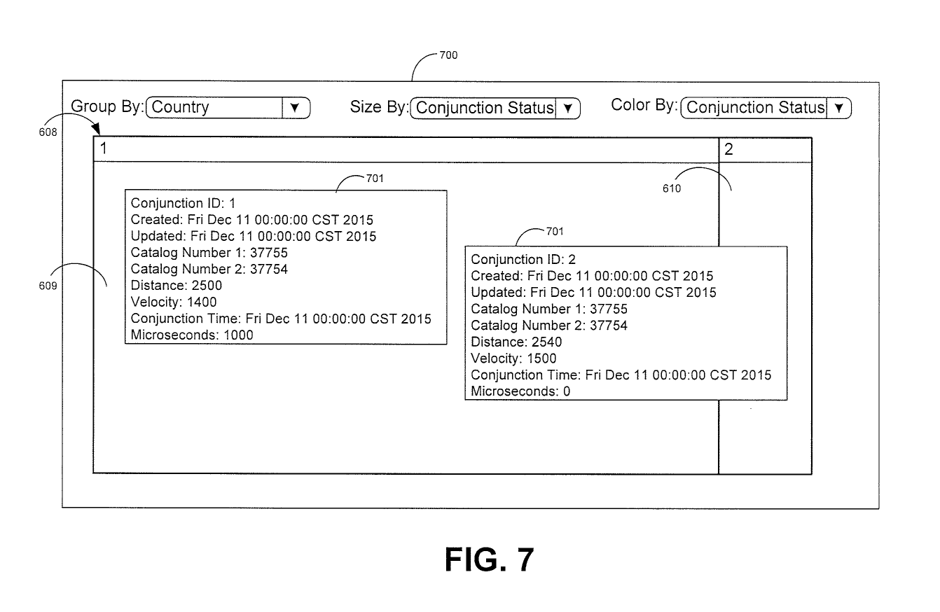

Additionally, the user 107 may select the pushbutton 521. If selected, the control logic 204 displays a Conjunction Detail view GUI 600 as shown in FIG. 6. The GUI 600 comprises a window pane 608 that comprises blocks 609 and 610 representative of the RSOs that are in jeopardy of collision. In the example provided, if the user 107 clicks on block 609, the control logic 204 translates the RSO characteristic data 210 associated with the conjunction and the first RSO, e.g., RSO “1,” and displays the translated data to a child window 701 as shown in FIG. 7. If the user 107 clicks on block 610, the control logic 204 translates the RSO characteristic data 210 associated with the conjunction and the second RSO, e.g., RSO “2,” and displays the translated data to a child window 702. The data contained in windows 701 and 702 is information indicative of conjunction, including the RSO conjunction identifier, when the information was created and updated, the potentially colliding satellite catalog numbers, the distance from collision, the velocity of the respective RSOs, and conjunction time. Note that the data listed in the child windows 701 and 702 may contain other types of RSO characteristic data 210 in other embodiments, and the above-referenced data is not limiting. In one embodiment, the RSO characteristic data 210 that is displayed in the child windows 701 and 701 is configurable by the user 107, and may include user-selections of any of the RSO characteristic data 210.

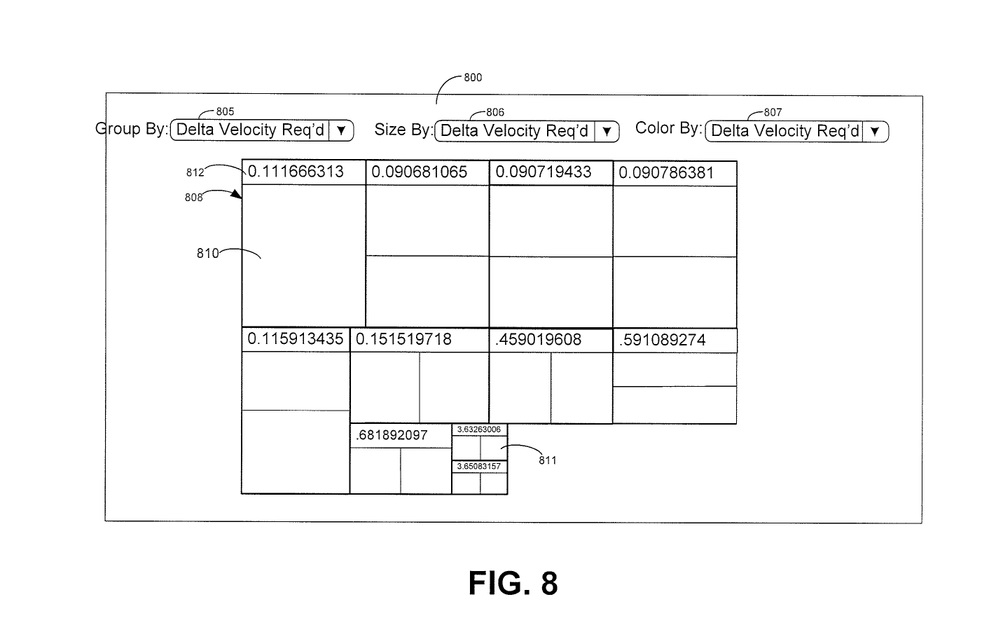

The user 107 may further select the Delta Velocity view from the Home GUI, and in response, the control logic 204 displays the Delta Velocity GUI 800 as shown in FIG. 8. The Delta Velocity view conveys information related to the potential of an RSO to be manually operated so as to cause a collision. More particularly, the Delta Velocity view conveys information regarding the potentiality that an RSO can be intentionally moved to cause a collision with another RSO.

In operation, the control logic 204 calculates the change in velocity for each RSO represented by the RSO characteristic data 210 that may result in a collision if the RSO is intentionally maneuvered. With reference to FIG. 8, the control logic 204 translates the calculated changes in velocity into geometric shapes, e.g., quadrilaterals, that depict the changes in velocity, and displays the Delta Velocity Required GUI 800 to the display device 203.

In this regard, the GUI 800 has a pane 808 that comprises a plurality of sub-blocks 810 and 811 that represent the translated RSO characteristic data 210 (FIG. 2). Note that only two sub-blocks 810 and 811 are identified in FIG. 8 for simplicity of discussion. However, the pane 808 comprises a plurality of sub-blocks.

Each of the sub-blocks 810 and 811 comprises headers 812 and 813, respectively. The headers 812 and 813 indicate the change in velocity that would result in a conjunction. In the exemplary sub-block 810, the change in velocity is “0.111666313” indicated in header 812. In the exemplary sub-block 811, the change in velocity is “3.63263006” indicated in header 813.

In one embodiment, the control logic 204 calculates the changes in velocity required for conjunction, translates the data indicative of the changes into geometric shapes, and displays the geometric shapes in increasing velocities from the top left sub-block 810 to the bottom right sub-block 811. Note that the differing sizes of the sub-blocks 810 and 811 indicate that the sub-block 810 identifies a change in velocity that is less than the change in velocity required as indicated by sub-block 811.

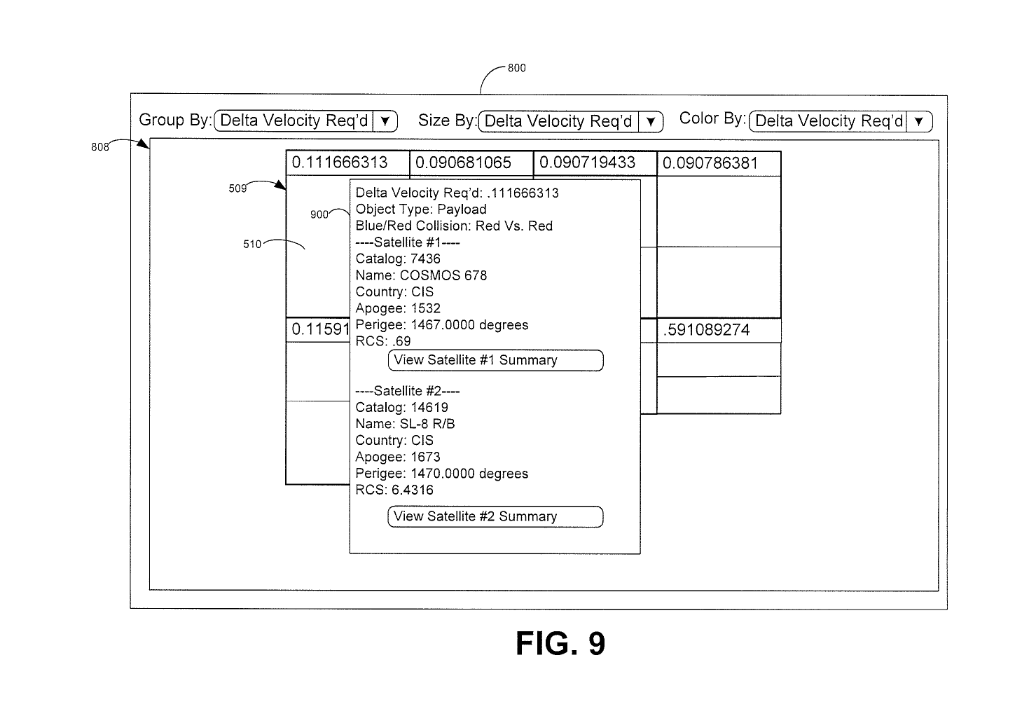

When a user 107 selects one of the sub-blocks, the control logic 204 displays data indicative of the potential conjunction. As an example, the user 107 may select the sub-block 801. In response, the control logic 204 displays a child window 900 as depicted in FIG. 9. The child window 900 comprises summary data for the two RSOs for which a conjunction may occur given the change in velocity. In this regard, the child window 900 comprises summary data for “Satellite #1,” indicating the catalog number, the name, the country, the apogee, the perigee, and the RCS of the first RSO. Additionally, the child window 900 comprises summary data for “Satellite #2,” also indicating the catalog number, the name, the country, the apogee, the perigee, and the RCS of the second RSO. Note that the data listed in the child window 900 may contain other types of RSO characteristic data 210 in other embodiments, and the above-referenced data is not limiting. In one embodiment, the RSO characteristic data 210 that is displayed in the child window 900 is configurable by the user 107, and may include user-selections of any of the RSO characteristic data 210.

Note that as indicated hereinabove, the Home GUI may comprise other selections in other embodiments, including Overflight, Two-Line Element, Anomalous Maneuver, Orbit Outlook, and JMS TLE View. Each of these other selections is further described.

In this regard, when the user 107 selects Overflight from the Home GUI, the control logic 204 translates the RSO characteristic data 210 into geometric shapes that convey satellite position over a pre-determined period of time, e.g., twenty-four hours.

When the user 107 selects the Two Line Element view, the control logic 204 translates the RSO characteristic data 210 into graphical elements grouped in blocks similar to FIG. 3. However, each block represents a two line element, and each sub-block represents an RSO.

Additionally, the user 107 may select an Anomalous Maneuver view. In the anomalous maneuver view, the control logic 204 virtually propagates the RSO a certain amount of time, e.g., one microsecond at a time. The control logic 204 compares the RSO positions after propagation to where it is located in the previous orbits to determine if the satellite has moved. In one embodiment, the control logic 204 may alert the user 107 to anomalous maneuvers, based upon the determination of movement.

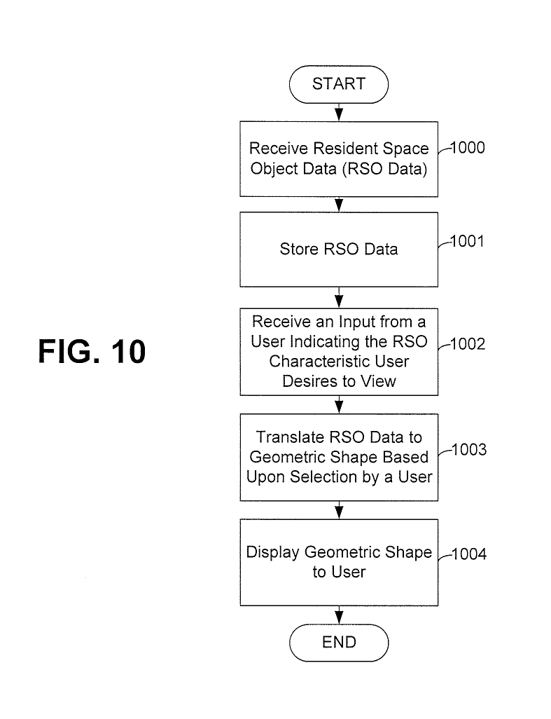

FIG. 10 is a flowchart illustrating exemplary architecture and functionality of the control logic 204 described hereinabove.

In block 1000, the control logic 204 (FIG. 2) receives resident space object data (RSO data) from a resident space object sensor system 104 (FIG. 1). The RSO data comprises RSO characteristic data 210 (FIG. 2) indicative of RSOs that are being tracked by the resident space object sensor system 104. The control logic 204 stores the RSO data received as indicated in block 1001.

In block 1002, the control logic 204 receives an input from a user 107 (FIG. 1) indicating what RSO characteristic data 210 the user 107 desires to view. As noted herein, the user may desire to view Unclassified Space Catalog, Collision Avoidance, Overflight, Two-Line Element, Delta Velocity Required, Anomalous Maneuver, Orbit Outlook, JMS TLE, and/or Allied User.

In response to the user selection, the control logic 204 translates RSO characteristic data 210 into geometric shapes in block 1003. In one embodiment, the control logic 204 translates the RSO characteristic data 210 to a plurality of quadrilaterals, wherein the size and color of the quadrilaterals convey information about the RSO corresponding to the RSO characteristic data 210. In block 1004, the control logic 1004 displays the plurality of quadrilaterals to a display device 203 (FIG. 2).

What is claimed is:

1. A system, comprising:
a resident space object (RSO) data server communicatively coupled to an RSO sensor system; and
logic configured for receiving RSO characteristic data from the RSO sensor system and storing the RSO characteristic data in resident memory, the logic further configured for receiving an input from a user identifying RSO characteristic data the user desires to view, the logic further configured for translating the RSO characteristic data into at least one geometric shape based upon the user's input and displaying the at least one geometric shape to an output device.

2. The system of claim 1, wherein the geometric shape is a quadrilateral.

3. The system of claim 1, wherein the logic translates the RSO characteristic data into the geometric shape wherein a size of the geometric shape is indicative of the RSO characteristic data.

4. The system of claim 1, wherein the logic translates the RSO characteristic data into the geometric shape wherein a color of the geometric shape is indicative of the RSO characteristic data.

5. The system of claim 1, wherein the user input is indicative of collision avoidance.

6. The system of claim 5, wherein the logic is further configured to calculate data indicative of a potential collision of two resident space objects.

7. The system of claim 6, wherein the logic is further configured to translate the calculated data indicative of the potential collision into the at least one geometric shape.

8. The system of claim 7, wherein the logic is further configured to display a color of the geometric shape that indicates the potential collision.

9. The system of claim 1, wherein the logic is further configured for translating the RSO characteristic data into a block representing one parameter of the RSO characteristic data.

10. The system of claim 9, wherein the logic is further configured for translating the RSO characteristic data into one or more sub-blocks, wherein each sub-block represents a second parameter of the RSO characteristic data, and the second parameter is associated with the first parameter.

11. The system of claim 10, wherein the sub-blocks are visually displayed associated within the block.

12. The system of claim 11, wherein the block has a first size, and the sub-blocks each have a second size.

13. The system of claim 12, wherein the logic is further configured to:
receive a selection of the block from the user;
translating RSO characteristic data corresponding to the first parameter and the first block into a block geometric shape having a size different that the first size;
translating RSO characteristic data corresponding to the second parameters and the sub-blocks into sub-block geometric shapes having sizes different from the second sizes; and
displaying the sub-block geometric shapes associated with the block geometric shape.

14. A method, comprising:
receiving, by a resident space object (RSO) data server, RSO characteristic data from a RSO sensor system communicatively coupled to the RSO data server;
storing the RSO characteristic data in resident memory;
receiving an input from a user identifying RSO characteristic data the user desires to view;
translating the RSO characteristic data into at least one geometric shape based upon the user's input; and
displaying the at least one geometric shape to an output device.

15. The method of claim 14, wherein the translation further comprises translating the RSO characteristic data to a quadrilateral.

16. The method of claim 14, further comprising translating the RSO characteristic data into the geometric shape wherein a size of the geometric shape is indicative of the RSO characteristic data.

17. The method of claim 14, further comprising translating the RSO characteristic data into the geometric shape wherein a color of the geometric shape is indicative of the RSO characteristic data.

18. The method of claim 14, wherein the user input is indicative of collision avoidance, further comprising calculating data indicative of a potential collision of two resident space objects.

19. The method of claim 18, further comprising translating the calculated data indicative of the potential collision into the at least one geometric shape.

20. The method of claim 19, wherein the displaying further comprising displaying a color of the geometric shape that indicates the potential collision.

21. The method of claim 1, further comprising translating the RSO characteristic data into a block representing one parameter of the RSO characteristic data.

22. The method of claim 21, further comprising translating the RSO characteristic data into one or more sub-blocks, wherein each sub-block represents a second parameter of the RSO characteristic data, and the second parameter is associated with the first parameter.

23. The method of claim 22, further comprising visually displaying the sub-blocks in association with the block.

24. The method of claim 23, wherein the block has a first size, and the sub-blocks each have a second size and further comprising:
receiving a selection of the block from the user;
translating RSO characteristic data corresponding to the first parameter and the first block into a block geometric shape having a size different that the first size;
translating RSO characteristic data corresponding to the second parameters and the sub-blocks into sub-block geometric shapes having sizes different from the second sizes; and
displaying the sub-block geometric shapes associated with the block geometric shape.
